(19) United States
(12) Patent Application Publication
(10) Pub. No.: US 2014/0139661 A1
(43) Pub. Date: May 22, 2014

(54) METHOD AND APPARATUS FOR ACQUIRING AND TRANSMITTING DYNAMIC VIDEOS

(71) Applicant: Electronics and Telecommunications Research Institute, Daejeon (KR)

(72) Inventor: Chung Hyun AHN, Daejeon (KR)

(73) Assignee: Electronics and Telecommunications Research Institute, Daejeon (KR)

(21) Appl. No.: 14/029,634

(22) Filed: Sep. 17, 2013

(30) Foreign Application Priority Data
Nov. 20, 2012 (KR) 10-2012-0131477

(51) Int. Cl. H04N 7/18

(52) U.S. Cl. CPC H04N 7/183
USPC 348/143

(57) ABSTRACT

The present invention relates to a method and apparatus for acquiring and transmitting dynamic videos which reflect the position and motion information of a video acquiring device. The video acquiring device comprises an AV acquiring module which photographs an object to acquire videos of the object, a location information acquiring module which acquires the location information of the video acquiring device or the user of the video acquiring device, a motion information acquiring module which acquires the motion information of the video acquiring device or the user of the video acquiring device, a multiplexing module which generates multiplexed signal by multiplexing the video, location information and motion information, and a wireless communication module which transmits the multiplexed signal to a mobile terminal equipped with wireless communication device via wired or wireless communication.

Priority to Korean patent application number 10-2012-0131477 filed on Nov. 20, 2012, the entire disclosure of which is incorporated by reference herein, is claimed.

### BACKGROUND OF THE INVENTION

1. Technical Field

The present invention relates to acquisition and communication of videos and, more specifically, to a method and apparatus for acquiring dynamic videos which reflect the position and motion information of a video acquiring device, and transmitting the videos through wired/wireless communication.

2. Discussion of Related Art

Location information service is making it possible to provide various location based services in the era of smart phones. The location information service can specify and provide the location of a person, objects and vehicles through GPS (Global Positioning System) at any time, and can specify and provide the location information with the accuracy of a few meters by using a base station or Wi-Fi.

Also, in the case of sensors detecting motions or movements, the sensors are minimized in scale to the degree that can be built in a mobile terminal, and in the case of video acquiring devices, camera modules for mobile phones with millions of pixels have been commercialized recently. Radio communication technology has been so developed that video communication between terminals are possible now, and recent 3GPP (3rd Generation Partnership Project) and 4G (4th Generation) mobile communication have enabled people to view HD (High Definition) level movies in real time. Further, due to the M2M (Machine-to-Machine) technology which enables autonomous communication between various terminals, communication of information between sensors and terminals can be performed without difficulty.

Now, people are claiming more sensational and dynamic video contents, and to meet these needs, various filming methods are being used including shooting a film by using a camera mounted on the surface of a helmet. FIG. 1 illustrates examples of general helmet-mounted cameras. Although an object can be photographed and by using a camera mounted on a helmet, as illustrated in FIG. 1, and video contents can be acquired from the camera, the location and of motion information of a user has not yet been considered and it is difficult to check the photographed video in real time.

### SUMMARY OF THE INVENTION

One technical objective of the present invention is to provide a method and apparatus for acquiring dynamic videos.

Another technical objective of the present invention is to provide a method and apparatus for transmitting the acquired dynamic videos through methods on the basis of wired or wireless communication.

Yet another technical objective of the present invention is to provide a method and apparatus for acquiring dynamic videos including the location information of users and motion information.

Still another technical objective of the present invention is to provide a method and apparatus for transmitting the acquired dynamic videos to a mobile terminal through wireless communication module.

According to one aspect of the present invention, a video acquiring device is provided. The device for acquiring videos comprises: an AV acquiring module which photographs an object to acquire videos of the object; a location information acquiring module which acquires the location information of the video acquiring device or the user of the video acquiring device; a motion information acquiring module which acquires the motion information of the video acquiring device or the user of the video acquiring device; a multiplexing module which generates multiplexed signal by multiplexing the video, location information and motion information; and a wireless communication module which transmits the multiplexed signal to a mobile terminal equipped with a wireless communication device via wired or wireless communication.

According to another aspect of the present invention, a system for acquiring videos comprising a video acquiring device and a mobile terminal is provided. The video acquiring device included in the system comprises: an AV acquiring module which photographs an object to acquire videos of the object; a location information acquiring module which acquires the location information of the video acquiring device or the user of the video acquiring device; a motion information acquiring module which acquires the motion information of the video acquiring device or the user of the video acquiring device; a multiplexing module which generates multiplexed signal by multiplexing the video, location information and motion information; and a wireless communication module which transmits the multiplexed signal to a mobile terminal equipped with wireless communication device via wired or wireless communication, and the mobile terminal included in the system receives the multiplexed signal and transmits the multiplexed signal received to a server via wireless communication.

According to yet another aspect of the present invention, a method for acquiring videos is provided. The method comprises the steps of: acquiring videos on an object by photographing the object by using a video acquiring device; acquiring the location information of the video acquiring device or the user of the video acquiring device; acquiring the motion information of the video acquiring device or the user of the video acquiring device; generating multiplexed signal by multiplexing the video, location information and motion information; and transmitting the multiplexed signal to a mobile terminal equipped with a wireless communication device via wired or wireless communication.

According to the present invention, users can view dynamic videos of events that they cannot experience in person such as extreme sports videos from the view of the user.

Also, when acquiring videos, location information of the user and motion information related to the movement of the user can be provided together, thereby enabling reestablishing the environments at the time of acquiring videos by applying the information to a simulator to be applied to immersive services including sports and games.

The present invention can also be used in special areas such as military activities or fire fighting, in which a commanding unit or a commander can identify the situations in the field by analyzing the location information and motion information of the user along with the videos acquired and send operation instructions to the user, thereby enhancing the efficiency of operation or practices.

### BRIEF DESCRIPTION OF THE DRAWINGS

FIG. 1 illustrates examples of helmet-mounted cameras.

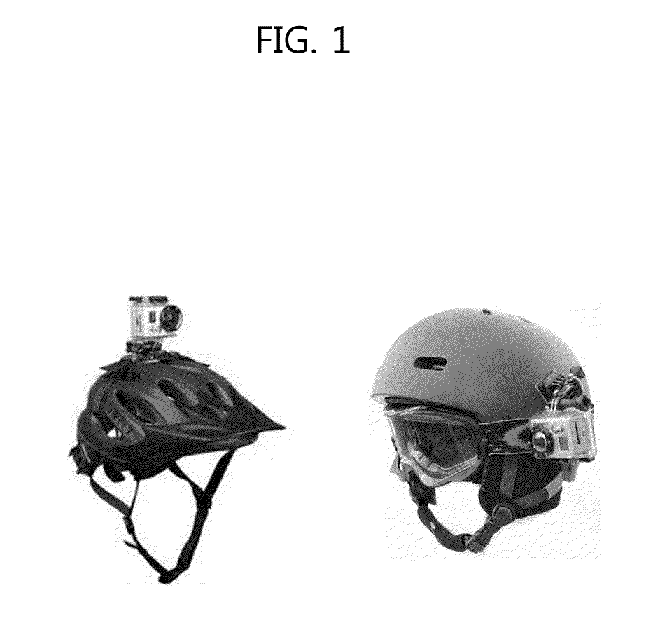

FIG. 2 is a diagram illustrating the structural of a video acquiring device according to one example of the present invention.

FIG. 3 illustrates a video acquiring device that can be built in glasses according to one example of the present invention.

FIG. 4 illustrates an example of utilizing a video acquired according to the method of the present invention.

FIG. 5 is a flow diagram illustrating the method of acquiring videos according to one example of the present invention.

FIG. 6 illustrates an example of an example of acquiring and transmitting video, and of utilizing the video acquired.

### DESCRIPTION OF EMBODIMENTS

Some examples of the present invention will be described below in the specification with reference to illustrative drawings. It should be noted that each reference numerals in the drawings are to be meant to indicate the same element when the numeral is the same although present in different drawings. Also, in explaining the examples of the present invention in the specification, detailed description on the well-known constructing element or functions related to the invention will be omitted when the specific explanation can obscure the features of the present invention.

If a component is referred to be “linked”, “coupled” or “connected” to another component in describing construction component of the present invention, the component may be directly linked or connected to the other component, or a third component may intervene to “link”, “couple” or “connect” the two components.

In describing operations of the components of this specification, the expression “photograph” can be used in combination with, or replaced by “imaging, shooting or filming”.

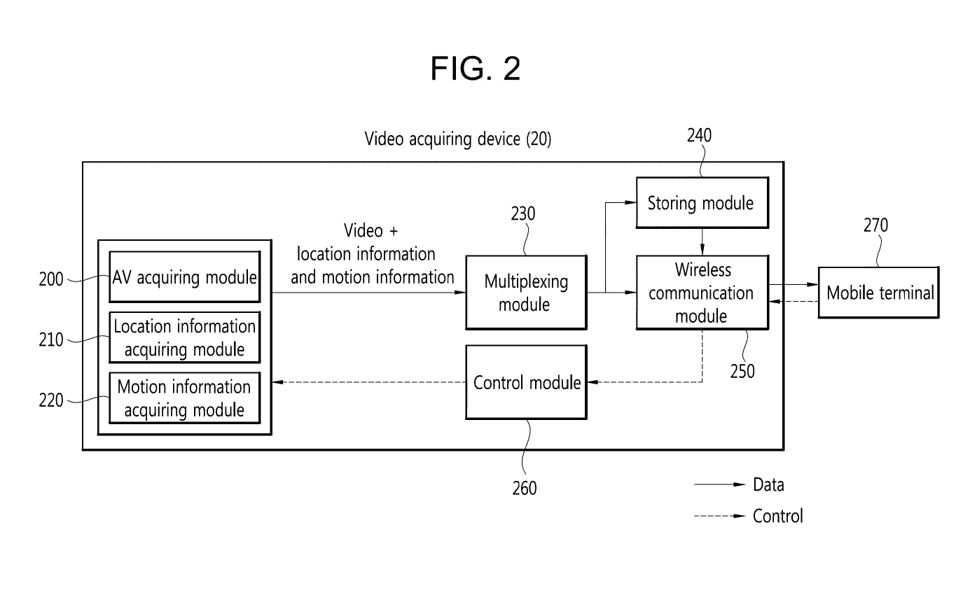

FIG. 2 is a diagram illustrating the structural of a video acquiring device according to one example of the present invention.

Referring to FIG. 2, video acquiring device 20 comprises an AV acquiring module 200, a location information module 210, a motion information module 220, multiplexing module 230, a storing module 240, a wireless communication module 250 and a control module 260. The video acquiring device 20 can be connected to a mobile terminal 270 via wired or wireless communication. Or, the video acquiring device 20 can be installed in the mobile terminal 270. The video acquiring device 20 can be implemented, in appearances, in the form of glasses, goggles or helmets, or can be implemented as a stand-alone type which can attached to glasses, goggles or helmets. Through the device, dynamic videos reflecting directional properties or the view of the user can be acquired.

The AV acquisition module 200 photographs an object to acquire videos of the object. Additionally, the AV acquiring module 200 can also acquire sounds. In the description below the term ‘videos’ may be meant to include sounds. The AV acquiring module 200 can comprise a small-scale video sensor and microphones. The video sensor can be a stereoscopic camera that can acquire stereoscopic video. In other words, the videos acquired by the AV acquiring module 200 can be stereoscopic video(image)s.

The location information module 210 acquires the location information of the video acquiring device 20 or the user using the video acquiring device 20. Here, the location information can mean the location information reflecting the time of acquiring the video by the AV acquiring module 200. The location information acquiring module 210 can comprise a GPS receiving sensor.

The motion information acquiring module 220 acquires the motion information of the video acquiring device 20 or the user of the device. Here, the motion information can mean the motion information reflecting the time of acquiring the video by the AV acquiring module 200. The motion information acquiring module 220 can, for example, be comprised of 6-axis sensor. The6-axis sensor can comprise a 3-axis acceleration sensors detecting spatial movements (X, Y, Z), and a 3-axis gyromagnetic sensor detecting directivity (X, Y, Z).

The multiplexing module 230 generates multiplexed signals by multiplexing the video acquired by the AV acquiring module 200, the location information acquired by the location information module 210 and the motion information acquired by the motion information module 220.

The storing module 240 stores at least one of the video, location information and motion information. Or, the storing module 240 stores the multiplexed signal. The storing module 240 can be a memory device. Meanwhile, at least one of the video, location information, motion information and multiplexed signal can be stored in a storing means equipped in the mobile terminal 270, in which case the storing module 240 can be omitted.

The wireless communication module 250 performs wired or wireless communication with the mobile terminal 270. The user can transmit the multiplexed signal to the mobile terminal 270 based on the communication, and the video acquiring device 20 can be monitored and controlled by the mobile terminal 270.

The control module 260 controls the video acquiring device 20. More specifically, the control module 260 controls the AV acquiring module 200, the location information module 210, the motion information module 220, the multiplexing module 230, the storing module 240 and the wireless communication module 250 included in the video acquiring device 20. The control module 260 can perform synchronization on the video, location information and motion information on the basis of the time the video is acquired by the AV acquiring module 200, and can control the multiplexing module 250 to perform multiplexing on the basis of the synchronized video, location information and motion information. The control module 260 can control the video acquiring device 20 according to a preset algorithm, or control the video acquiring device 20 by receiving a control signal through a separate input device installed on the video acquiring device 20, or control the video acquiring device 20 by receiving a control signal from the mobile terminal 270.

The video acquiring device 20 can further comprise a power supply module such as a battery for supplying power, or can be connected to an external power supplying means provided outside the device. Or the video acquiring device 20 can share the power of the mobile terminal 270.

The user can acquire the videos according to the direction or viewpoint of the viewer through the video acquiring device 20 as described above, or, can combine (reflect) the location information and motion information of the user to the video. The video acquiring device 20 can transmit the location information and the video in which the motion information is combined (or reflected), i.e., the multiplexed signal to the mobile terminal 270 through wired or wireless communication, and the mobile terminal 270 can control and monitor the video acquiring device 20. In some cases, the mobile terminal 270 can store the transmitted location information and the video in which the motion information is combined (or reflected) to a (internal) storing means of the mobile terminal 270, or can output the multiplexed signal through a display means of the mobile terminal 270. Or, the signal can be transmitted to outside (e.g., a server located outside) by using a radio communication function of the mobile terminal 270.

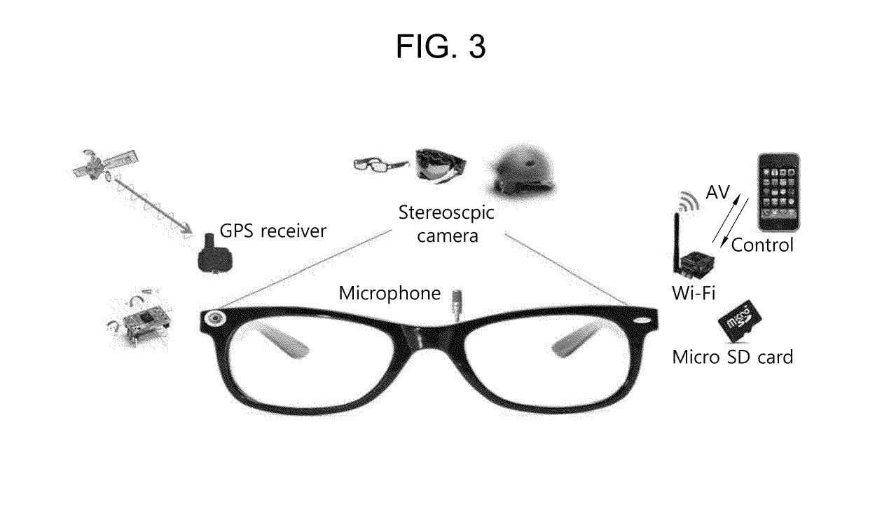

FIG. 3 illustrates a video acquiring device that can be built in glasses according to one example of the present invention.

Referring to FIG. 3, the video acquiring device built in glasses are equipped with a stereoscopic camera and a microphone as the AV acquiring module, a GPS receiver as the location information module, and a gyro sensor as the motion information module. Also, the video acquiring device built in glasses performs communication with a mobile terminal such as a smart phone through a Wi-Fi device which is equipped as the wireless communication module. Through the module, the video acquiring device built in glasses can acquire the video accompanying the location information and motion information and transmit the information to the mobile terminal, and receive a control signal from the mobile terminal. Also, the video acquiring device built in glasses can further comprise a micro SD card as the storing module.

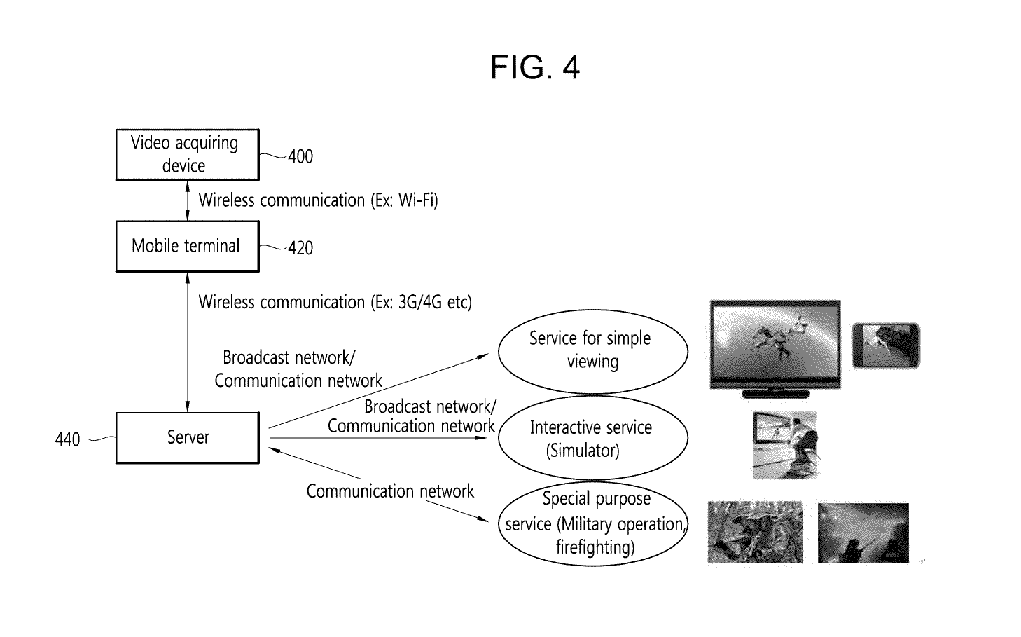

FIG. 4 illustrates an example of utilizing a video acquired according to the method of the present invention.

Referring to FIG. 4, the video acquiring device 400 transmits the multiplexed signal including the video, location information and motion information to the mobile terminal 420 through wireless radio communication (e.g., Wi-Fi or Bluetooth).

The mobile terminal 420 transmits the multiplexed signal to the server 440 through wireless communication (e.g., 3GPP 3rd generation/4th generation).

The server 440 can provide various services on the bases of the multiplexed signal.

As one example, the video, location information and motion information included in the multiplexed signal can be provided as a service for simple viewing. Here, the service for simple viewing means the media service for simply viewing, through TV or other display device of a terminal, the AV (Audio Video) contents transmitted from the acquiring device by using the media service of broadcast network or communication network.

As another example, the video, location information and motion information included in the multiplexed signal can be provided as an interactive service. Here, the interactive service means game-type media service utilizing the location information and motion information along with the AV (Audio Video) contents transmitted from the acquiring device by using the media service of broadcast network or communication network, in which the viewer can experience real situation by reflecting the movement of the actual operator of the acquiring device in the movement of the simulator.

As yet another example, the video, location information and motion information included in the multiplexed signal can be provided in the field of special-purposes. Here, the field of special-purposes means services in the public field of special purposes such as military operations, anti-terror operations and fire fighting in which situations of the sites are identified by instructors and instructions for operation can be transmitted to operators based on the AV (Audio Video) information collected from the operators at the site in real time.

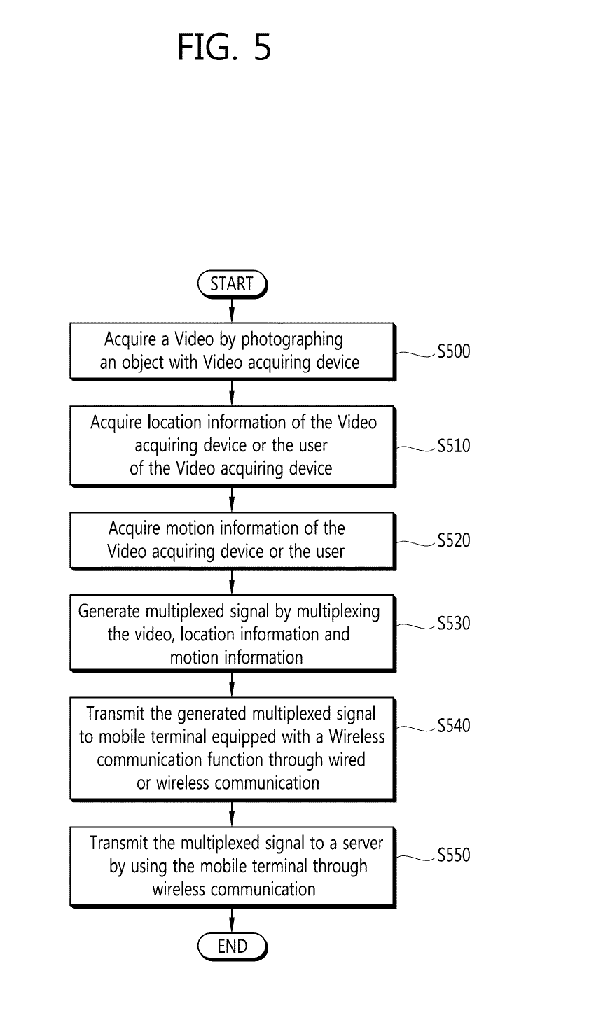

FIG. 5 is a flow diagram illustrating the method of acquiring videos according to one example of the present invention.

Referring to FIG. 5, the video acquiring device photographs an object and acquires videos on the object (S500). Here, the video can include sounds. Also, the video can be a stereoscopic video(image).

The video acquiring device acquires the location information of the video acquiring device or the user who uses the video acquiring device (S510). Here, the location information can mean the location information reflecting the time of acquiring the video by the video acquiring device.

The video acquiring device acquires the motion information of the video acquiring device or the user (S520). Here, the motion information can represent the motion information reflecting the time of acquiring the video by the video acquiring device.

The video acquiring device generates a multiplexed signal by multiplexing the video, location information and motion information (S530). Meanwhile, the video acquiring device can perform synchronization on the video, location information and motion information on the basis of the time of acquiring the video, and can perform multiplexing of the video, location information and motion information on the basis of the time. Also, the video acquiring device can store at least one of the video, location information and motion information. Also, the video acquiring device can store the multiplexed signal.

The video acquiring device transmits the multiplexed signal to a mobile terminal equipped with a radio communication function through wired or wireless communication (S540). In this case, the mobile terminal can store the multiplexed signal in an internal storing means or outputs the signal to a display means. Also, the mobile terminal can generate and transmit a control signal to the video acquiring device for controlling the video acquiring device.

The mobile terminal transmits the multiplexed signal received to a server through wireless communication (S550). In this case, the server can convert the signal for a specific purpose and provide the service in various forms of services. Through these services, viewers can view dynamic videos of events that are difficult to experience in person from the perspective of the actual operator.

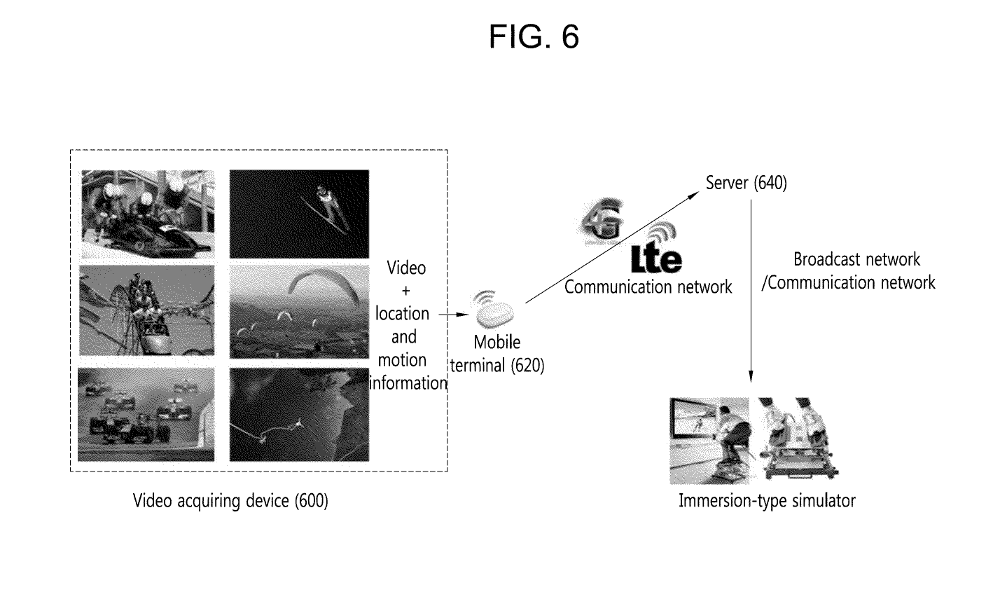

FIG. 6 illustrates an example of an example of acquiring and transmitting a video, and of utilizing the video acquired.

Referring to FIG. 6, the video acquiring device 600 according to the present invention acquires the video (including stereoscopic video) of an object. Or, the video acquiring device 600 acquires the location information and motion information of the video acquiring device 600 or the user using the video acquiring device 600 at the time the video is acquired. The video acquiring device 600 generates multiplexed signal by multiplexing the video and the location information and motion information at the time of the video acquisition, and transmit the signal to the mobile terminal 620 via wired/wireless communication. The mobile terminal 620 can transmit the multiplexed signal to a server 640 through wireless communication such as 4G (generation) or LTE (long term evolution), and the server 640 can process the multiplexed signal including the video, location information and motion information, and provide the results to viewers through at least one of broadcast network and communication network. In this case, the viewers can reestablish the environments through an immersion-type simulator on the basis of the location information and/or motion information at the time of video acquisition for application to an immersion-type services such as sports or games. The present invention can also be used in special areas such as military activities or firefighting, in which a commanding unit or a commander can identify the situations in the field by analyzing the location information and motion information of the user along with the videos acquired and send operation instructions to the user, thereby enhancing the efficiency of operation or practices.

It should be appreciated that the above description has been made to illustrate the technical idea of the present invention, and can be corrected and modified within the scope of the essential features of the present invention by those skilled in the art to which the present invention pertains to. Therefore, the examples in the specification of the present invention should be considered not to limit the technical idea of the present invention but illustrate the present invention. In sum, and the present invention shall not be limited by the examples but shall be interpreted by the claims attached in terms of the scope of the invention, and any technical ideas equivalent to that of the present invention shall be considered to be within the scope of the present invention.

What is claimed is:

1. A device for acquiring videos, which comprises:
an AV acquiring module which photographs an object to acquire videos of said object;
a location information acquiring module which acquires the location information of said video acquiring device or the user of said video acquiring device;
a motion information acquiring module which acquires the motion information of said video acquiring device or the user of said video acquiring device;
a multiplexing module which generates multiplexed signal by multiplexing said video, said location information and said motion information; and
a wireless communication module which transmits said multiplexed signal to a mobile terminal equipped with a wireless communication device via wired or wireless communication.

2. The device of claim 1, further comprising a control module which synchronizes said video, said location information and said motion information based on the time of acquiring said video.

3. The device of claim 1, further comprising a storing module which stores at least one of said video, said location information and said motion information.

4. The device of claim 1, wherein said wireless communication module receives control signals from said mobile terminal.

5. A system for acquiring videos comprising a video acquiring device and a mobile terminal,
wherein said video acquiring device comprises:
an AV acquiring module which photographs an object to acquire videos of said object;
a location information acquiring module which acquires the location information of said video acquiring device or the user of said video acquiring device;
a motion information acquiring module which acquires the motion information of said video acquiring device or the user of said video acquiring device;
a multiplexing module which generates multiplexed signal by multiplexing said video, said location information and said motion information; and
a wireless communication module which transmits said multiplexed signal to a mobile terminal equipped with wireless communication device via wired or wireless communication,
and wherein said mobile terminal receives said multiplexed signal and transmits said multiplexed signal received to a server via wireless communication.

6. The system of claim 5, wherein said video acquiring device further comprises a control module which synchronizes said video, said location information and said motion information based on the time of acquiring said video.

7. The system of claim 5, wherein said video acquiring device further comprises a storing module which stores at least one of said video, said location information and said motion information.

8. The system of claim 5, wherein said mobile terminal stores said multiplexed signal in an internal storing means.

9. The system of claim 5, wherein said mobile terminal outputs said multiplexed signal through a display means.

10. The system of claim 5, wherein said mobile terminal transmits a control signal to said video acquiring device for controlling said video acquiring device.

11. A method for acquiring videos, which comprises the steps of:
acquiring videos on an object by photographing said object by using a video acquiring device;
acquiring the location information of said video acquiring device or the user of said video acquiring device;
acquiring the motion information of said video acquiring device or the user of said video acquiring device;
generating multiplexed signal by multiplexing said video, said location information and said motion information; and
transmitting said multiplexed signal to a mobile terminal equipped with a wireless communication device via wired or wireless communication.

12. The method of claim 11, further comprising the step of synchronizing said video, said location information and said motion information based on the time of acquiring said video.

13. The method of claim 11, further comprising the step of storing at least one of said video, said location information and said motion information.

14. The method of claim 11, further comprising the step of storing said multiplexed signal.

15. The method of claim 11, further comprising the step of receiving a control signal from said mobile terminal.

16. The method of claim 11, further comprising the step of transmitting said multiplexed signal received to a server via wireless communication of said mobile terminal.
